(19) United States
(12) Patent Application Publication
(10) Pub. No.: US 2008/0197649 A1
(43) Pub. Date: Aug. 21, 2008

(54) METHOD AND APPARATUS FOR TRANSPORTING CARGO THAT IS TEMPERATURE OR MOISTURE SENSITIVE

(75) Inventors: Geoffrey G. Byler, Lake Oswego, OR (US); Donalea Byler, Lake Oswego, OR (US)

Correspondence Address: MARGER JOHNSON & MCCOLLOM, P.C., 210 SW MORRISON STREET, SUITE 400, PORTLAND, OR, 97204, US

(73) Assignee: BLUE PLANET LOGISTICS, Wilsonville, OR (US)

(21) Appl. No.: 12/031,600

(22) Filed: Feb. 14, 2008

Related U.S. Application Data
(60) Provisional application No. 60/890,102, filed on Feb. 15, 2007.

(51) Int. Cl. B60R 13/08

(52) U.S. Cl. 296/39.3

(57) ABSTRACT

A method and apparatus for protecting temperature sensitive materials, such as live plants, in transit. The method comprises suspending an insulative liner in spaced relationship from a ceiling and side walls of a cargo container, wherein the insulative liner includes a woven fabric layer sandwiched between two reflective layers.

### CROSS-REFERENCES TO RELATED APPLICATIONS

This application claims the benefit from U.S. Provisional Patent Application No. 60/690,102 filed Feb. 15, 2007 whose contents are incorporated herein for all purposes.

### BACKGROUND OF THE INVENTION

1. Field of the Invention

This disclosure relates to transportation of temperature or moisture sensitive cargo and more particularly to insulative methods and liners for providing temperature and/or humidity stabilization for such cargo during transport.

2. Description of the Prior Art

Some cargo, such as nursery plants being transported from a wholesale nursery to a retail seller of plants, may be shipped for thousands of miles and through widely varying climates. When shipped plants are grouped together in a relatively sealed container, such as an enclosed trailer or rail container, they produce moisture and heat as can be observed in a greenhouse or terrarium. During certain seasons of the year or when shipping through certain climates, the plants must be shipped in refrigerated trailers or containers to preserve the plants. Refrigerated shipping, however, is expensive-as well as being subject to price volatility—and in short supply. Furthermore, refrigerated trailers are heavier and carry about 10% less payload than non-refrigerated (e.g. “dry”) trailers. This drives up the cost of shipping plants.

Accordingly, the need remains for means to forgo the need for heavy and expensive environmental control systems for use in shipping temperature and moisture sensitive cargo such as live plants.

### SUMMARY OF THE INVENTION

This application discloses a reusable shipping liner that provides a suitable humidity seal as well as a heat barrier. The liner may be used in enclosed truck trailers or in cargo containers, such as rail trailers/containers. It may be used to protect and preserve all kinds of cargo that may be sensitive to humidity or temperature such as plants, paint, food, wine, etc. This liner obviates the need for expensive refrigerated shipping.

The invention comprises an insulative liner for use with a cargo container of the type having an interior space defined by elongate side walls running a length of the cargo container, a floor and ceiling, a front wall, and a back door. The insulative liner comprises a top insulative panel having a reflective coating running approximately the length of the cargo container. A plurality of suspension points is arrayed in parallel rows along the length of the top insulative panel. Means for suspending the top insulative panel from the ceiling of the cargo container via the suspension points are included so that the top insulative panel is maintained in a suspended position spaced from the ceiling of the cargo container with the reflective coating of the top insulative panel facing the interior space of the cargo container. Side insulative panels are coupled along opposing side edges of the top panel and hanging down adjacent to side walls of the cargo container. Finally, a front panel is coupled along a front edge of the top panel and hangs down adjacent to the front wall of the cargo container.

The method comprises suspending an insulative liner in spaced relationship from a ceiling and side walls of a cargo container, wherein the insulative liner includes a woven fabric layer sandwiched between two reflective layers. The method further includes providing a plurality of rows of loops along a top panel of the insulative liner, with a row defined at least adjacent long peripheral edges of the top panel. For each row of loops, one runs a cord serially through each loop in the row and attaches the cord to front and back ends of a ceiling of the cargo container to thereby suspend the liner from the ceiling of the cargo container. The side panels are then coupled to long peripheral edges of the top panel so that the side panels hang parallel to side walls of the cargo container.

The foregoing and other objects, features and advantages of the invention will become more readily apparent from the following detailed description of a preferred embodiment of the invention that proceeds with reference to the accompanying drawings.

### BRIEF DESCRIPTION OF THE DRAWINGS

FIG. 1 is a perspective view in partial section of a semi tractor trailer cargo container with suspended liner implemented and installed according to the invention.

FIG. 2 is a side elevation view of one side of the suspended liner of FIG. 1.

FIGS. 3A and 3B show rear elevation views of the liner and cargo container of FIG. 1 using various means for suspending the insulative liner within cargo container.

FIGS. 4A and 4B show magnified perspective views of the suspension means of FIGS. 3A and 3B.

FIG. 5A and 5B illustrate alternate embodiments of the liner used in the environment of FIG. 1 in perspective views with layers of each embodiment pealed away to illustrate its multi-layer structure.

### DETAILED DESCRIPTION

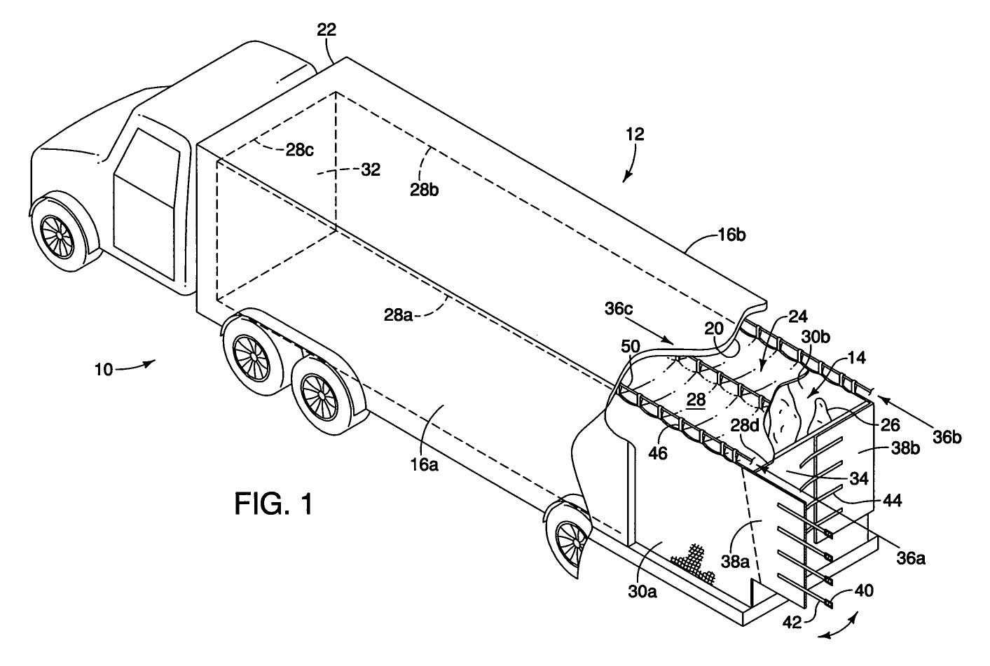

FIG. 1 illustrates a semi tractor trailer 10 of a type carrying a standard-sized cargo container or trailer 12. The cargo container 12 has an interior space 14 defined by elongate side walls 16a, 16b running a length of the cargo container 12, a floor 18 and ceiling 20, a front wall 22, and a back door (not shown).

The cargo container 12 is fitted with an insulative liner 24 of a type adapted for transport of temperature sensitive materials such as live plants 26 and constructed in accordance with the present invention. The liner is shown in the position it assumes when it is suspended inside the cargo container 12 or truck trailer, as will shortly be described.

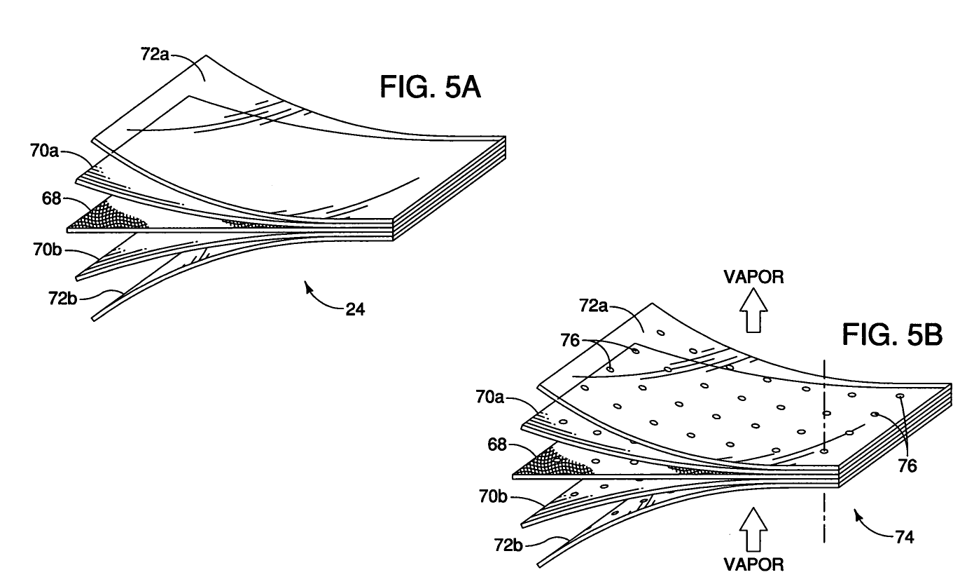

In its preferred implementation, liner 24 includes five sides. A top insulative panel 28, having a reflective coating (see, e.g. FIGS. 5A, 5B), runs approximately the length of the cargo container 12. Side insulative panels 30a, 30b are coupled (e.g. sewn) along opposing side edge 28a, 28b seams to the top panel 28 and hang down adjacent to side walls 16a, 16b to the floor 18 of the cargo container 12. A front panel 32 is coupled along a front edge seam 28c to the top panel and hangs down adjacent to the front wall 22 of the cargo container 12. Finally, a back panel 34 is coupled along a back edge seam 28d to the top panel 28 and hangs down adjacent to the back door (not shown) of the cargo container 12. Back panel 34 is rolled up when cargo is loaded or unloaded and left down during transport.

The arrangement and preferred method of attachment of panels to one another to form liner 24 is described below. Four-foot panels are sewn together using a double-needle lockstitch to create the front 32, side 30a/30b and rear 34 eight-foot panels and footer as well as the roof panel 28. Then each side is adjoined to the roof panel 28 by a double-needle chain stitch-such as side panels 30a/30b coupled along seams 28a/28b—thereby offering greater tensile strength and elasticity at points of stress when the liner 24 is hung. All seams are sewn in uninterrupted lengths from the front to the back of the liner using heavy duty nylon thread. Back closure buckles are also sewn onto the rear flaps (e.g. buckles 40 on portions 38a/38b described below) for greater strength.

Insulative liner 24 is suspended in spaced relationship from the ceiling 20 and side walls 16a, 16b of the cargo container 12. Suspension is effected via a plurality of suspension points arrayed in parallel rows along the length of the top insulative panel 24. In FIG. 1, the preferred embodiment shown includes three rows of suspension points, including side rows 36a, 36b adjacent to points along each long peripheral edge 28a, 28b of the top panel, and a center row 36c along a centerline axis of the top panel.

Side panels 30a, 30b have a length greater than a length of the top insulative panel 28, with portions 38a, 38b being configured to fold inward toward a portion of the opposite side panel and attached thereto. In this way, each side panel 30a, 30b extends to the rear beyond rear panel 34 to form a pair of upright “doors” 38a, 38b that can be folded over the rear panel 34 and buckled together using buckles, like buckle 40 and straps 42 mounted to door 38a. Straps 42 are each engaged with a corresponding buckle 40 to close the rear of the liner over rear panel 34 during transport by engaging with a strap 44 on an opposing door 38b.

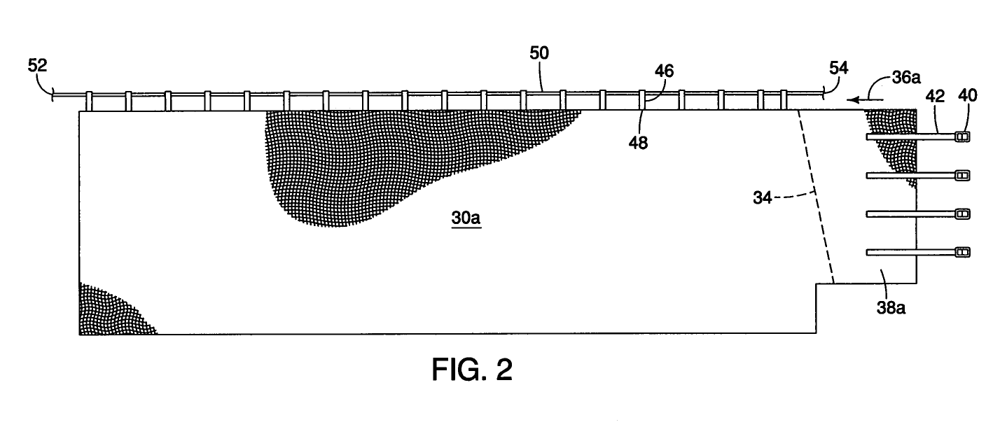

FIG. 2 is a side elevation view of a single one of the side panels 30a. Shown in FIG. 1 and FIG. 2 are means for suspending the top insulative panel 28 from the ceiling 20 of the cargo container 12 via the suspension points, such as row 36a shown in FIG. 2, so that the top insulative panel is maintained in a suspended position spaced from the ceiling 20 of the cargo container 12 with the reflective coating (described below with reference to FIGS. 5A and 5B) of the top insulative panel 28 facing the interior space 14 of the cargo container 12.

In a first preferred embodiment, as shown in FIGS. 1-3A and 4A, the means for suspending the top panel 28 of liner 24 includes a loop for each suspension point, such as loop 46 at suspension point 48. Each of the rows of suspension points, such as row 36a with suspension point 48, are coupled in common to the ceiling 20 of the cargo container 12 via a rope 50 passing though each loop within the row. It is understood that the term rope is intended cover any elongate element passed through each of the loops such as cables, chains, or the like. The rope 50 is run serially through each loop in the row and is attached to front and back ends 52, 54 of the ceiling 20 of the cargo container 12 to thereby suspend the liner from the ceiling of the cargo container.

The side panels 30a, 30b are sewn along their upper edge to the respective outer edges of top panel 28. As a result, the trailer interior is lined on five sides (all but the floor) with the liner.

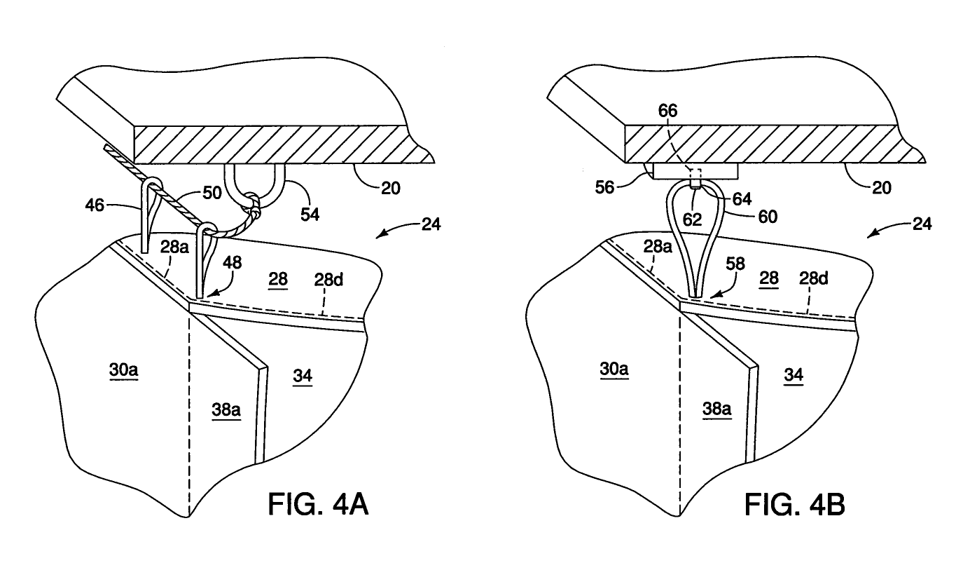

In use, three ropes, such as rope 50, are run through each row of loops 36a, 36b, and 36c. The ropes are in turn secured to the interior of the trailer using commercially available plastic tie fasteners, or ends tied to brackets mounted within the container. FIG. 4A shows a bracket at a rear end 54 of the container 12. After installation, plants or other cargo are loaded, and the rear portion of side panels 38a, 38b are buckled together. Because the material within the liner 24 acts as an effective heat barrier, the cargo tends to maintain its temperature within the lined container. During cold weather, heat radiated by the plants is reflected back into the interior of the lined container and absorbed by the plants. In warm weather, the liner reflects solar heat absorbed by the container and radiated inward into the interior of the container.

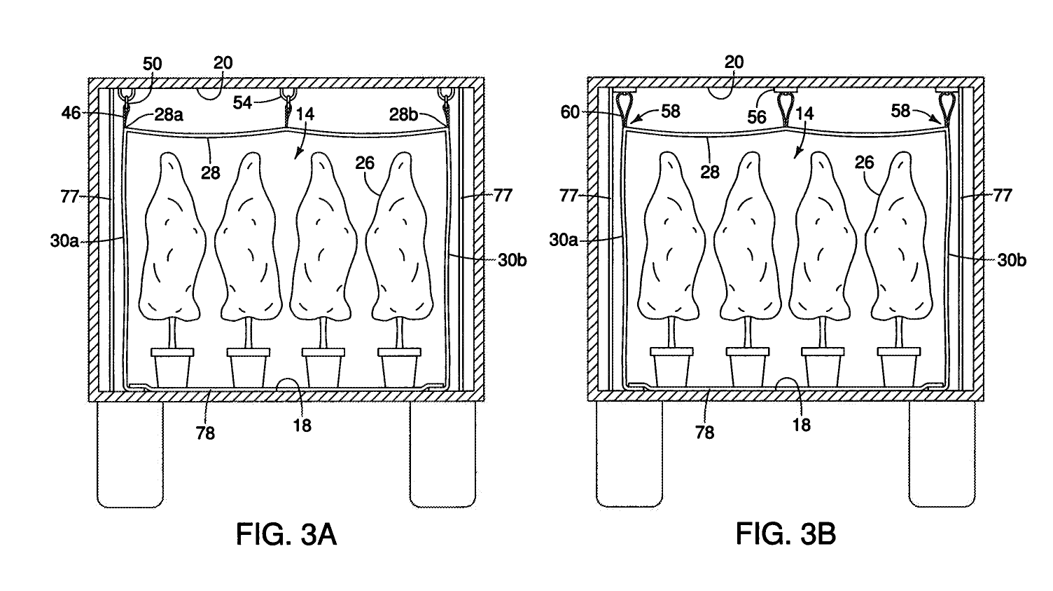

In an alternate embodiment of the suspension means, as shown in FIG. 3B and 4B, the means for suspending the top panel 28 of liner 24 via the suspension points includes, for each suspension point, a magnet 56 coupled in spaced relation to the suspension point 58 via a connector (e.g. loop 60) wherein the magnet 56 is adapted to magnetically couple to the ceiling of the cargo container and between a top panel 28 of the insulative liner 24 and the ceiling 20 of the cargo container 12. In a preferred implementation of this alternate suspension means, five magnetic ceramic disks (each two inches in diameter by ¼ inches thick, and capable of holding up to 40 pounds) are attached to the regular liner hanging loops 60 using rivets 62 inserted through a small hole 64 made at the top of each loop 60 and a corresponding hole 66 in the magnetic disk 56. The magnets are placed in the corners and along the upper side and down the middle of a container 12, which holds the liner 24 in place during transit.

FIG. 5A illustrates the multi-layer nature of liner 24 implemented according to a preferred embodiment of the invention. The figure is shown fanned out so that each layer can be seen distinctly. Each panel of liner 24 includes a woven polyethylene layer 68 sandwiched between two reflective layers 70a, 70b. The reflective layers 70a, 70b are preferably formed of aluminum of 98% purity. Each panel of liner 24 further includes a clear polyester layer 72a, 72b covering each of the two reflective layers 70a, 70b.

FIG. 5B illustrates a multi-layer of liner 74 implemented according to an alternate embodiment of the invention. Like FIG. 5A, the figure shown is fanned out so that each layer can be seen distinctly. Each panel of liner is the same as shown in FIG. 5A, with the addition that perforations 76 extend through each of the five layers in at least one of the panels used within the liner 24. The perforations are made within the liner 24 in a pattern shaped and sized to allow humidity to pass through the perforated panel.

It has been found that the moisture retaining properties of the liner 74 can be modulated by forming holes through the material. For example, leafy plants do not require as much moisture as other plants, and the holes permit escape of moisture from the interior of the liner to provide a moisture level suitable for those plants.

In extremely hot weather it may be desirable to provide some additional insulation, especially with a metal container. This can be provided by lining the cargo container walls with honey-combed cardboard insulating material 77 (see, e.g. FIGS. 3A and 3B) or otherwise interposing the cardboard between the liner 24 and the container walls. This also diminishes heat transfer that might otherwise result from contact of the liner material with the metal container wall.

A vapor barrier 78 (FIGS. 3A and 3B), such as a polyethylene sheet, can be used on the floor 18. In cold weather, the moisture generated by the plants can freeze the containers to the floor of the trailer. The vapor barrier prevents this from happening.

After use, the liner can be removed, refurbished, and recycled for later reuse as described below. To begin the process, ropes 50 are untied from the front 52 and back 54 of one side only (e.g. the side holding row 36a). This can be easily reached without a ladder. Next, one would untie the center rope (holding row 36c) leaving the liner flat up against one side of the container, e.g. container side 16b. While in this position, it is much easier to get the liner flat against the inside wall of the trailer 12. The preferred method is to find the seams and fold along each of those seam lines, e.g. along seam lines 28a.

Once the liner 24 has been released from the final hanger rope 50, e.g. the rope holding row 36b, it is preferred to roll the liner over with the ceiling side down. This has been found to be an effective position to ensure a tight refolding, and will place the side panels 30a, 30b in the up position. The liner should then be pressed as flat as possible.

With the seams aligned together as the liner lay on its top, the side hanger loops 46 should be visible on each side. One would make sure to work from the front to the back of the trailer 12 on both sides pulling the seams together so that the sides lay flat. Once this is done, the liner should be pulled tight at both ends.

With the liner flat on the floor of the trailer 12 with side hanger loops 46 visible, the liner 24 should be folded. Starting in the front of the trailer, the liner should be folded to maintain it in as flat a condition as possible. Sides of the liner should be tucked, and folded like wrapping a package. As one folds the liner from the front of the trailer to the back, each fold will get larger in width as one progresses. After each fold, one should smooth the liner from the center outward to keep the liner flat and straight. One can then walk back and forth on the first few folds to help keep it flat. Continue this process until you get to the back of the trailer where you will end up with the liner 24 in a configuration that will be approximately four feet wide and eight feet long. One can then walk on the folded portion to push out all trapped air.

Finally, one should fold the four-foot width portion in half to get a two-foot portion. Then one should fold the eight-foot portion in thirds to end up with an object approximately thirty-six inches in width. The resulting folded liner can then be placed in a storage bag or box and unpacked for reuse.

Having described and illustrated the principles of the invention in a preferred embodiment thereof, it should be apparent that the invention could be modified in arrangement and detail without departing from such principles. We claim all modifications and variation coming within the spirit and scope of the following claims.

What is claimed is:

1. An insulative liner for use with a cargo container of the type having an interior space defined by elongate side walls running a length of the cargo container, a floor and ceiling, a front wall, and a back door, the insulative liner comprising:
a top insulative panel having a reflective coating running approximately the length of the cargo container;
a plurality of suspension points arrayed in parallel rows along the length of the top insulative panel;
means for suspending the top insulative panel from the ceiling of the cargo container via the suspension points so that the top insulative panel is maintained in a suspended position spaced from the ceiling of the cargo container with the reflective coating of the top insulative panel facing the interior space of the cargo container;
side insulative panels coupled along opposing side edges of the top panel and hanging down adjacent to side walls of the cargo container; and
a front panel coupled along a front edge of the top panel and hanging down adjacent to the front wall of the cargo container.

2. The insulative liner of claim 1, further including at least three rows of suspension points, including at least a row along each long peripheral edge of the top panel and along a centerline long axis of the top panel.

3. The insulative liner of claim 2, wherein the means for suspending the top insulative panel from the ceiling of the cargo container via the suspension points includes, for each suspension point, a magnet coupled in spaced relation to the suspension point via a connector wherein the magnet is adapted to magnetically couple to the ceiling of the cargo container.

4. The insulative liner of claim 2, wherein the means for suspending the top insulative panel from the ceiling of the cargo container via the suspension points includes, for each suspension point, a loop.

5. The insulative liner of claim 4, wherein each of the rows of suspension points are coupled in common to the ceiling of the cargo container via a rope passing through each loop within the row.

6. The insulative liner of claim 1, wherein the side insulative panels have a length greater than a length of the top insulative panel, with a portion hanging beyond an end of the top panel being configured to fold inward toward a portion of the opposite side panel and attach thereto.

7. The insulative liner of claim 6, further including a back panel coupled along a back edge of the top panel and hanging down adjacent to the back door of the cargo container, the portions of the side insulative panels hanging beyond the end of the top panel being configured to fold inward over the back panel.

8. The insulative liner of claim 1, wherein each panel of the liner includes a woven polyethylene central layer sandwiched between two reflective layers.

9. The insulative liner of claim 8, wherein each panel of the liner further includes a clear polyester layer covering each of the two reflective layers.

10. The insulative liner of claim 9, wherein the reflective layers are formed of aluminum.

11. The insulative liner of claim 9, further including perforations through each of the layers in at least one of the panels in a pattern configured to allow humidity to pass through the perforated panel.

12. A method for protecting temperature sensitive materials such as living plants in transit, the method comprising:
suspending an insulative liner in spaced relationship from a ceiling and side walls of a cargo container, wherein the insulative liner includes a woven fabric layer sandwiched between two reflective layers.

13. The method of claim 12, further including:
providing a plurality of rows of loops along a top panel of the insulative liner, with a row defined at least adjacent long peripheral edges of the top panel;
for each row of loops, running a cord serially through each loop in the row and attaching the cord to front and back ends of a ceiling of the cargo container to thereby suspend the liner from the ceiling of the cargo container; and
coupling side panels to long peripheral edges of the top panel so that the side panels hang parallel to side walls of the cargo container.

14. The method of claim 13, further including folding extended portions of the side panels at a back end inward toward an opposing side panel and attaching said extended portions to one another.

15. The method of claim 12, further including coupling a plurality of magnets between a top panel of the insulative liner and the ceiling of the cargo container.

16. The method of claim 12, further including interposing a honey-combed cardboard insulating material between the insulative liner and walls of the cargo container.

17. An insulative liner for use with a cargo container of the type having an interior space defined by elongate side walls running a length of the cargo container, a floor and ceiling, a front wall, and a back door, the insulative liner comprising a plurality of insulative panels interposed between the walls, ceiling and back door of the of cargo container and the cargo container interior space, each of said panels having substantially reflective front and back surfaces configured to reflect radiant heat from the container walls back toward the container walls and reflect radiant heat from the interior space back toward the interior space.

18. The insulative liner of claim 17, wherein the liner includes a woven fabric layer sandwiched between two reflective layers.

19. The insulative liner of claim 17, further including:
a plurality of suspension points arrayed in parallel rows along a length of a top insulative panel, the top insulative panel being one of the plurality of insulative panels; and
means for suspending the top insulative panel from the ceiling of the cargo container via the suspension points so that the top insulative panel is maintained in a suspended position spaced from the ceiling of the cargo container with one of the reflective surfaces of the top insulative panel facing the interior space of the cargo container.

20. The insulative liner of claim 17, further including:
a back insulative panel coupled to a rear portion of the top insulative panel, the back insulative panel being one of the plurality of insulative panels; and
extended portions of side panels folded over the back insulative panel so that the folded over extended portions are interposed between the back insulative panel and the back door of the cargo container.
